(19) United States
(12) Patent Application Publication
(10) Pub. No.: US 2003/0028335 A1
(43) Pub. Date: Feb. 6, 2003

(54) Method and device for diagnosing flow resistance in the intake tract of internal combustion engines

(76) Inventors: Ernst Wild, Oberriexingen (DE); Werner Mezger, Eberstadt (DE); Klaus Ries-Mueller, Bad Rappenau (DE)

Correspondence Address: KENYON & KENYON, ONE BROADWAY, NEW YORK, NY, 10004, US

(21) Appl. No.: 10/045,446

(22) Filed: Nov. 9, 2001

(30) Foreign Application Priority Data
Nov. 14, 2000 (DE) 100 56 431.3

(51) Int. Cl. G01L 7/00; G01N 11/00; G01F 17/00; G06F 19/00; G01F 23/00

(52) U.S. Cl. 702/50

(57) ABSTRACT

A method and a device are proposed for diagnosing flow resistance in the intake tract of internal combustion engines, which permit ascertaining the flow resistance in the intake tract with sufficient accuracy, using only one pressure sensor, in order, for example, to be able to diagnose a fouled air filter. This is done by measuring the suction pipe pressure in unthrottled operation at low and at higher air mass flow, and the flow resistance in the intake tract is inferred from the pressure difference.

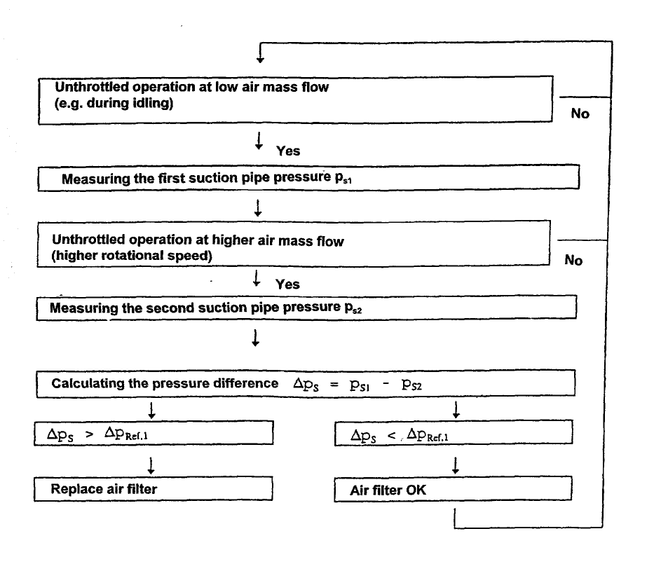

### FIELD OF THE INVENTION

The present invention relates to a method and a device for diagnosing flow resistance in the intake tract of internal combustion engines.

### BACKGROUND

The flow resistance in the intake tract of internal combustion engines has considerable influence on performance, emission and the fuel consumption of internal combustion engines. Thus, for example, flow resistance in the intake tract of internal combustion engines can increase because of a fouled air filter, which brings with it the above-named disadvantages. Failure of the air filter or a leak in the intake tract also have disadvantageous effects on the internal combustion engine.

From German Published Patent Application No. 197 30 578 it is known that, by measuring the pressure upstream from the air filter and the boost pressure of a supercharged internal combustion engine one can infer the manifold air pressure of the supercharger. To do this, two pressure sensors are required, which leads to corresponding costs. Besides that, the two sensors have to be calibrated to each other so that the diagnosis of the flow resistance does not come out wrong because of a systematic error arising from measurement errors of the pressure sensors.

### SUMMARY OF THE INVENTION

An object of the present invention is based on making available a method and a device with which the diagnosis of the flow resistance in the intake tract of internal combustion engines can be carried out in a simple manner and with sufficient accuracy.

The object is attained according to the present invention by a method for diagnosing the flow resistance in the intake tract of internal combustion engines in which a first intake tract pressure is measured at low air mass flow, a second intake tract pressure is measured at high intake tract pressure, the pressure difference is calculated from the first intake tract pressure and the second intake tract pressure, the pressure difference is compared to a first reference value and a signal is emitted when the pressure difference is greater than the first reference value.

The method according to the present invention permits diagnosing the flow resistance in the intake tract of internal combustion engines, using only one pressure sensor. This is made possible by measuring the suction pipe pressure at various operating states of the internal combustion engine, and inferring the flow resistance from the difference of the measured suction pipe pressures. This saves costs by using only one pressure sensor, and in addition, it makes unnecessary the problem of having to calibrate two pressure sensors with each other so as to make possible a sufficiently accurate ascertainment of the pressure difference.

Idling represents a suitable operating state of the internal combustion engine for carrying out the method according to the present invention at low air mass flow, whereas an operating state with high air mass flow appears at full throttle and high engine speed of the internal combustion engine. This means that, even without a special air flow sensor, the method according to the present invention can ascertain the air mass flow in the intake tract by evaluating engine speed and accelerator position.

In variants of the present invention, it is provided that the method steps shall take place regularly, in particular when the change between operating states of the internal combustion engine with low air mass flow and with high air mass flow, and vice versa, occurs within a time Δt of 60 seconds, preferably within 30 seconds, so that even a change in flow resistance in the intake tract, appearing during the operation of the internal combustion engine, can be diagnosed. That makes it possible, for example, to diagnose a fouled air filter whose flow resistance is significantly greater than that of a new air filter, and to recognize the required replacement of the air filter by the emission of an appropriate signal. If the measurement of the first suction pipe pressure and the second suction pipe pressure are made within a time period Δt of 60 seconds, this ensures that the measurement results do not come out wrong because of a superposed change of the environmental pressure, for example, during the drive through a pass in the mountains.

In a further embodiment of the method according to the present invention, compensation for geodetic altitude can be carried out, for example, by evaluation of GPS data present in the vehicle, so that the accuracy of the measurement is further increased.

In order to be able to diagnose damage in the intake tract or a missing air filter, it is provided that the pressure difference is to be compared with a second reference value and that a signal is emitted is smaller than the second reference value. The second reference value is smaller than the first reference value.

In a further supplementation of the method according to the present invention, the first reference value and/or the second reference value are determined as a function of the operating state of the internal combustion engine and of the environmental conditions, so that a further improvement in the diagnosis of flow resistance can be achieved.

In a still further variant of the present invention, suction pipe pressure is calculated from the air mass flow, so that one can do without a pressure sensor.

The method according to the present invention and the device according to the present invention are not restricted to diagnosing flow resistance in the intake tract, but can also be used for diagnosing flow resistance in the exhaust system of an internal combustion engine.

### BRIEF DESCRIPTION OF THE DRAWING

The Figure shows a flow diagram of an exemplary embodiment of the method according to the present invention. The method according to the present invention is especially suitable for use with Diesel engines and gasoline engines having direct injection in stratified-charge operation, since there one travels at open throttle.

### DETAILED DESCRIPTION

A control unit (not shown) polls at regular intervals whether an unthrottled operation at low air mass flow is present, such as an idling operation. If that is not the case, polling is repeated at a certain time delay. When unthrottled operation at low air mass flow is present, a first suction pipe pressure P₁ₛ is measured. This is followed by a polling as to whether an unthrottled operation at higher air mass flow is present, that is, at higher rotational speed of the internal combustion engine. If that is not the case, the method is started over again. If unthrottled operation at higher air mass flow is present, a second suction pipe pressure Pₛ₂ is measured. Then follows the calculation of the pressure difference Δpₛ=Pₛ₁−Pₛ₂. By comparing the pressure difference Δpₛ with a first reference value Δp_{ref,1} it is determined whether the flow resistance of the intake tract is unduly high or not. If the flow resistance is unduly high, a signal is emitted that the air filter has to be replaced. If the flow resistance in the intake tract lies within the admissible values, the air filter is all right and the method according to the present invention can be run through again.

What is claimed is:

1. A method for diagnosing a flow resistance in an intake tract of an internal combustion engine, comprising the steps of:
measuring a first suction pipe pressure at a low air mass flow;
measuring a second suction pipe pressure at a high air mass flow;
calculating a pressure difference from the first suction pipe pressure and from the second suction pipe pressure;
comparing the pressure difference with a first reference value; and
emitting a signal when the pressure difference is greater than the first reference value.

2. The method according to claim 1, wherein:
the method is performed regularly during an operation of the internal combustion engine.

3. The method according to claim 2, wherein:
the method is always performed when a change between operating states of the internal combustion engine having the low air mass flow and having the high air mass flow and vice versa occurs within a time space At of 60 seconds.

4. The method according to claim 2, wherein:
the method is always performed when a change between operating states of the internal combustion engine having the low air mass flow and having the high air mass flow and vice versa occurs within a time space At of 30 seconds.

5. The method according to claim 1, further comprising the step of: compensating for a geodetic altitude.

6. The method according to claim 1, further comprising the steps of:
comparing the pressure difference to a second reference value; and
emitting another signal when the pressure difference is smaller than the second reference value.

7. The method according to claim 6, further comprising the step of:
determining at least one of the first reference value and the second reference value as a function of an operating state of the internal combustion engine and of an environmental condition.

8. The method according to claim 1, further comprising the step of:
calculating the first suction pipe pressure and the second suction pipe pressure from the low air mass flow and the high air mass flow.

9. A computer program for causing a processing device to perform the steps of:
measuring a first suction pipe pressure at a low air mass flow;
measuring a second suction pipe pressure at a high air mass flow;
calculating a pressure difference from the first suction pipe pressure and from the second suction pipe pressure;
comparing the pressure difference with a first reference value; and
emitting a signal when the pressure difference is greater than the first reference value.

10. The computer program according to claim 9, wherein:
the computer program can be stored on a storage medium.

11. A control unit for performing the steps of:
measuring a first suction pipe pressure at a low air mass flow;
measuring a second suction pipe pressure at a high air mass flow;
calculating a pressure difference from the first suction pipe pressure and from the second suction pipe pressure;
comparing the pressure difference with a first reference value; and
emitting a signal when the pressure difference is greater than the first reference value.

12. A device for diagnosing a flow resistance in an intake tract of an internal combustion engine, comprising:
a control unit;
a pressure sensor disposed in the intake tract; and
a sensor for measuring a low air mass flow and a high air mass flow, wherein the control unit:
measures a first suction pipe pressure at a low air mass flow,
measures a second suction pipe pressure at a high air mass flow,
calculates a pressure difference from the first suction pipe pressure and from the second suction pipe pressure,
compares the pressure difference with a first reference value, and
emits a signal when the pressure difference is greater than the first reference value.

13. The device according to claim 12, further comprising:
equipment for registering a geodetic altitude of the internal combustion engine.
